(19) United States
(12) Patent Application Publication
(10) Pub. No.: US 2008/0208608 A1
(43) Pub. Date: Aug. 28, 2008

(54) System and Method for Exchanging Cases Entrusted to Expert by Clients

(76) Inventor: Kyung Sik Jeong, Seoul (KR)

Correspondence Address: WEINER & BURT, P.C., 635 N US-23, POB 186, HARRISVILLE, MI, 48740, US

(21) Appl. No.: 11/995,741

(22) PCT Filed: Jul. 14, 2006
(86) PCT No.: PCT/KR06/02778

§ 371 Date: Jan. 15, 2008

(30) Foreign Application Priority Data
Jul. 15, 2005 (KR) 10-2005-0064082

(51) Int. Cl. G06Q 99/00

(52) U.S. Cl. 705/1

(57) ABSTRACT

Disclosed therein are a system and method for exchanging cases entrusted to experts by clients, which can maximize expertise by exchanging cases entrusted by clients with experts in an expert group in a one-to-one manner. The system for exchanging cases entrusted to experts by clients in which experts in expert groups can exchange cases entrusted by clients with each other through a wired or wireless network, includes: an expert terminal for enabling an expert to register his or her specialized field and entrusted case information and request case exchange or to apply transfer of a case registered by other expert; and a case exchanging server for mediating case exchange through the steps of receiving and admitting a subscription of experts engaged in various fields, storing the expert's specialized field and career information of case handling received as member information in a member information DB, providing the information to other experts, receiving case exchange registration including case information, and providing the case exchange registration to other experts. The present invention provides an exchange service that an individual expert A in an expert group which has priority to expertise transfers a case entrusted by a client to other expert B who has better expertise and receives another case from the expert B in return for the case transfer, thereby enhancing expertise of the expert group and providing the client with more specialized service.

### TECHNICAL FIELD

The present invention relates to a system and method for exchanging cases entrusted to experts by clients, and more particularly, to such a case exchanging system and method, which enable an expert and another expert to exchange their own entrusted cases with each other with the consent of the client when the expert requests the other expert, who is well versed in the relevant field, of transfer of the entrusted case and the other expert consents the case transfer.

### BACKGROUND ART

According to a policy of progressive opening of human services (professional services), from the year 2006 or at latest from the year 2008, necessity of strengthening of competitive power in taxation business, industrial property business and other professional services including the legal market in Korea gains force due to opening of markets.

Till now, expert groups who are engaged in professional services, for example, lawyers, patent attorneys, doctors, herb doctors, licensed tax accountants, accountants, and architects, have accepted and handled cases without reconsideration of expertise in a specific field required for the cases if the cases entrusted by a client are applicable to the expert's business area. Of course, the expert groups are experts in the relevant fields who have been previously verified in their knowledge and technology in the relevant fields. However, in the actual situation that the business area of the professional field is gradually subdivided and requires precise expertise and know-how, there is a great difference in quality of expertise of a specific field between experts of the same business kind.

However, actually, the client who brings a case to an expert entrusts the case to the expert on trust in the external form and fame of the expert group since the client is not easy to grasp the movement of the relevant specialized field and runs short of knowledge of the relevant specialized field. Moreover, the client has to hold all expenses and responsibility when the case did not come off with a result that the case was progressed without verification of that the entrusted expert had sufficient expertise and experiences of the corresponding case.

So, to strengthen the competitiveness in specialized services of the expert groups, which have competed with one another in a small number, the business field must be subdivided and experts who are well versed in each field microscopically must be formed. Therefore, in consideration of importance of the specialized human services not to simply sell services but to protect human rights and private material and immaterial properties and serve as driving force for moving the nation, a win-win oriented cooperation network which is rational and of help to the expert group is necessary.

### DISCLOSURE OF INVENTION

### Technical Problem

Accordingly, it is an object of the present invention to provide a system and method for exchanging cases under expert cooperating circumstances, which enable experts specialized in each field to register data capable of proving their own specialized field and expertise and to exchange their own entrusted cases with each other, who are members of an expert group, in consideration of a party's expertise.

### Technical Solution

To accomplish the above object, according to the present invention, there is provided a system for exchanging cases entrusted to experts by clients that experts in expert groups can exchange cases entrusted by clients with each other through a wired or wireless network, comprising: an expert terminal for enabling an expert to register his or her specialized field and entrusted case information and request case exchange or to apply transfer of a case registered by other expert; and a case exchanging server for mediating case exchange through the steps of receiving a subscription from the expert terminal, admitting experts' subscriptions in various fields, storing the expert's specialized field and career information of case handling received as member information in a member information DB, providing the information to other experts, receiving case exchange registration including case information, and providing the case exchange registration to other experts.

According to a preferred embodiment of the present invention, the case exchanging server includes: a member information for managing part receiving and admitting the expert's subscription and storing the expert's specialized field and career information of case handling as member information; a case exchange registering part storing a case exchange registration including case information; a case public announcement part for publicly announcing the case registered for case exchange to other expert members; a case exchange request managing part for receiving a case exchange request that the expert (registrant) selects at least one other expert and requests case exchange, and transmitting the case exchange request to the selected expert; a transfer application managing part for receiving a transfer application that other expert (inquirer) who inquired the publicly announced case selects the expert (registrant) and applies transfer of the case, and transmitting it to the expert (registrant); and an exchange approving part for transmitting exchange approval that the expert (registrant) finally approves case exchange to the at least one expert candidate who applied transfer of the case.

In another aspect, there is provided a method for exchanging cases entrusted to experts by clients that a case exchanging server enables experts in expert groups to exchange cases entrusted by clients with each other through a wired or wireless network, comprising the steps of: (1) receiving a subscription and member information from an expert terminal, storing them in a member information DB, and admitting the subscription by the case exchanging server; (2) receiving case exchange registration information including case information from the expert terminal and storing it in a case exchange registration DB; (3) inquiring and transmitting an expert list of a specialized field corresponding to the entrusted case to the expert terminal; (4) when the expert terminal selects at least one other expert from the expert list and requests exchange of the case, notifying the selected expert of case exchange request information; (5) when the selected expert reviews the case exchange request information and makes a transfer application, notifying the expert (registrant of the entrusted case) of transfer application information; and (6) completing exchange of the entrusted case when the expert (registrant) receiving the notification of the transfer application information finally approves case transfer.

### BRIEF DESCRIPTION OF THE DRAWINGS

The following figures attached to the present invention illustrate preferred embodiments of the present invention and serve to make understand the following detailed description of the preferred embodiment and technical spirit of the present invention, and so, the present invention is not restricted to the accompanying drawings.

FIG. 1 is a view of a network configuration of a system for exchanging cases entrusted to experts by clients according to the present invention.

FIG. 2 is a functional view of the system for exchanging cases entrusted to experts by clients.

FIG. 3 is a view of the internal structure of a case exchanging server according to the present invention.

FIG. 4 is a flow chart showing a method for exchanging cases entrusted to experts by clients according to the present invention.

FIG. 5 is a flow chart showing a process of progressing an expert's transfer application of other expert's entrusted case according to the present invention.

FIG. 6 is a view of a tree configuration that cases and specialized fields are categorized according to the present invention.

FIG. 7 is an exemplary view of a screen configuration of the system for exchanging cases entrusted to experts by clients according to the present invention.

### MODE FOR THE INVENTION

Reference will be now made in detail to the preferred embodiment of the present invention with reference to the attached drawings.

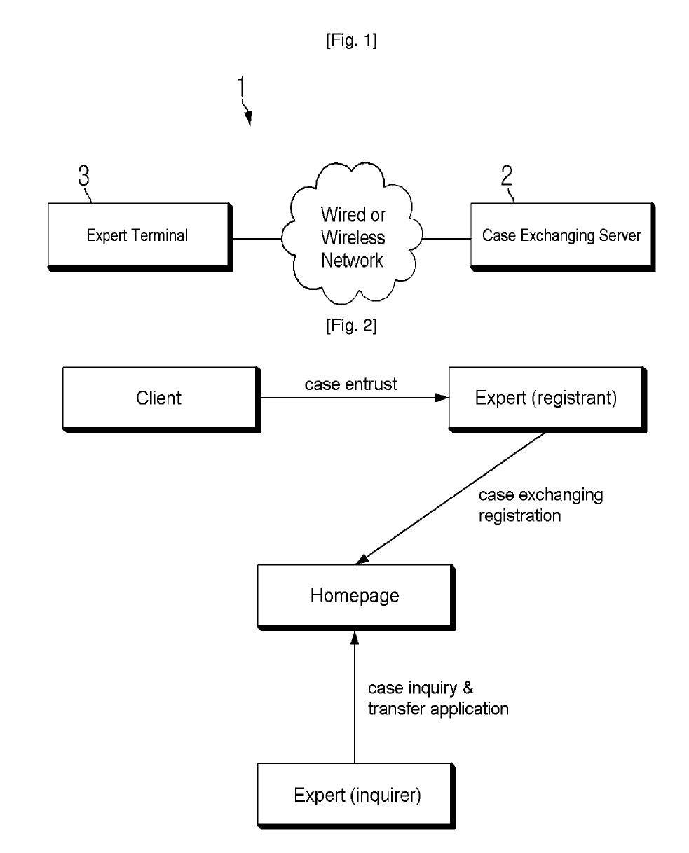

FIG. 1 shows a network configuration of a case exchanging system 1 according to a preferred embodiment of the present invention.

The case exchanging system 1 according to the present invention includes a case exchanging server 2 and an expert terminal 3, which are connected with each other through a wired or wireless network for transmitting and receiving data.

The case exchanging server 2 is equipped with user interface means for mediating exchange of entrusted cases between experts subscribed through the wired or wireless network. For an example of the user interface means, there is a TCP/IP-based server program for interfacing through a program for web server or client's exclusive use for managing homepage interfacing through client browser.

FIG. 2 shows an example that the case exchanging server 2 interfaces with the experts (users) through homepage. Each expert accepts a case at a client's request. The expert may directly handle the accepted case, but judge that it is good to request to other expert who is more perfect for handling the case or be in a dedicate situation that the expert cannot accept the case due to too many accepted cases.

The case exchanging server 2 provides a mediation service enabling the experts to exchange their entrusted cases by receiving information of a case registered by the subscribed expert under the above circumstances and publicly announcing a request of exchange of the case to other experts. The expert who registered the case may, as a positive manner, directly select at least one other expert who is well versed in a specialized field related with the case and tap the selected expert's intention of case exchange, or, as a passive manner, receive a request of case transfer from at least one expert who inquires into the publicly announced case and determine whether or not to exchange the case.

The expert terminal 3 is a terminal enabling data communication through the wired or wireless network, and for the expert terminal 3, there are mobile phones, computers, and PDAs. The expert can connect to the case exchanging server 2 using the expert terminal 3, and then, register his or her own case for requesting case exchange or apply transfer of other expert's case. For such service, the expert has to subscribe to the case exchanging server 2, and the case exchanging service according to the present invention may be provided for free or charged.

Preferably, the experts in the present invention are not restricted to persons who are engaged in specific business kinds, but specialists who can provide material or immaterial services by showing their specialized abilities. For example, there are connoisseurs, architects, patent attorneys, lawyers, licensed tax accountants, doctors, accountants, and so on.

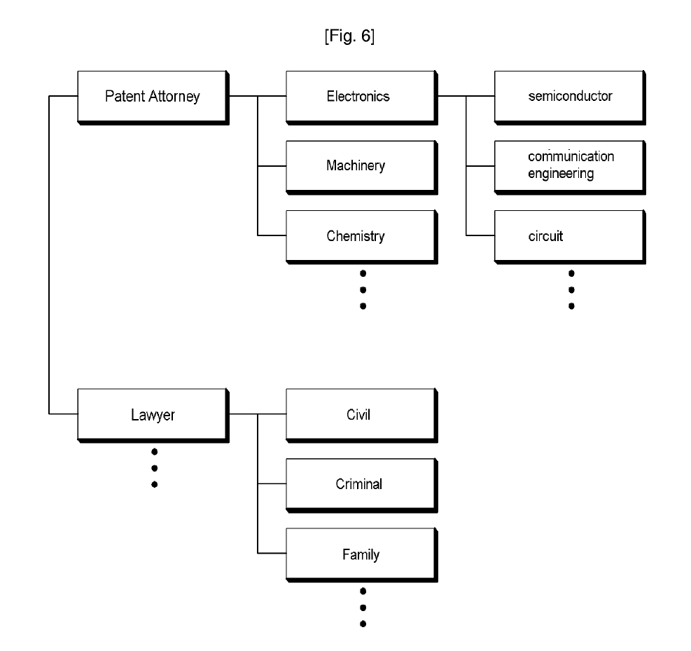

Preferably, the cases or specialized fields in the present invention must be classified into prescribed categories. In fact, since cases entrusted to the expert by the client are very extensive and, according to circumstances, need knowledge of a field making an issue of the case rather than the expert's knowledge, it is necessary to classify the cases and specialized fields into the prescribed categories. FIG. 6 shows an example of such category structure.

Preferably, the expert registers his or her personal information, specialized field, and career of case handling in the specialized field after subscribing to the case exchanging server 2. The specialized field and career of case handling in the specialized field are opened to other experts when the case is exchanged, so as to be used as objective public data. After that, the expert updates and manages his or her own information of career of case handling at any time. For example, in case of a suit for medical care of a lawyer group, when a lawyer microscopically deals with a case through public announcement of individual cases, such as lasik in ophthalmology, plastic operation in surgery, or implant in dentistry, and cases in litigation, and wins a lawsuit or successfully settles the case through exchange of the case, a handling process of the case is reflected to career information in detail, so as to be used as a foreign advertisement data for securing expertise.

Therefore, the expert has to pay attention in registering his or her own career information and accepted case information (summary, entrustment price, features, and exchange conditions of the case).

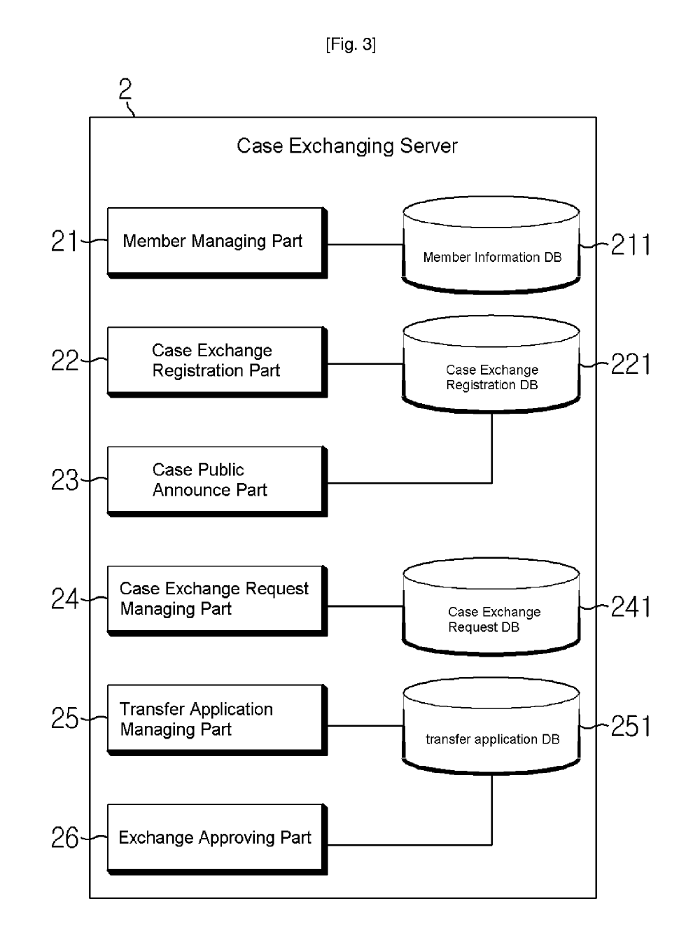

FIG. 3 shows the internal structure of the case exchanging server 2 according to the present invention.

The case exchanging server 2 according to the present invention includes a member managing part 21, a case exchange registering part 22, a case public announcement part 23, a case exchange request managing part 24, a transfer application managing part 25, and a exchange approving part 26. Moreover, the case exchanging server 2 further includes, as a DBMS structure, a member information DB 211, a case exchange registration DB 221, a case exchange request DB 241, and a transfer application DB 251.

The member managing part accepts an expert's subscription by receiving member information after receiving the expert's subscription from the expert terminal 3. The member information includes the user's personal information, specialized field, and career information of case handling in the specialized field, and is stored in the member information DB 211.

The case exchange registering part 22 receives a request of exchange registration of cases entrusted to the expert by the client, and stores case information in the case exchange registration DB 221. The case information includes summary, entrusting cost, features and exchange conditions of the case.

The case public announcement part 23 inquires into information of cases registered now for exchange from the case exchange registration DB 221 and provides the case information to the experts who log in. If the expert sets up his or her specialized field and interested field, the case public announcement part 23 can search and provide the corresponding case information.

After the expert registers an entrusted case, the case exchange request managing part 24 inquires into other experts who are engaged in specialized field corresponding to the specialized field category of the entrusted case, creates an expert list, and then transmits it to the expert terminal 3. When the expert (registrant) selects at least one other expert and requests case exchange, the case exchange request managing part 24 receives case exchange request information, stores information of the selected expert in the case exchange request DB 241, and individually notifies it to the selected expert in order to inquire whether or not the selected expert has an intention to exchange the case.

The transfer application managing part 25 receives a transfer application for exchange of the entrusted case from the selected expert or other expert who inquired into the publicly announced case, stores it in the transfer application DB 251, and then, notifies the expert of information of the transfer application.

The expert (registrant) receives information of at least one other expert candidate who made the transfer application in connection with the expert's case exchange request, and then, selects one specific person and finally approves the case exchange.

The exchange approving part 26 receives information of other expert (inquirer) who was finally selected as the object for case exchange by the expert, approves the case exchange, and then, updates data of the case, which the case exchange request has been progressed till now, as a completed case.

As described above, when the expert (registrant)'s entrusted case is transferred to the expert (inquirer), the expert (inquirer) concludes a contract with the client and progresses the case. In addition, the expert (inquirer) is under an obligation to transfer his own case to the expert (registrant) later on in order to complete the mutual case exchange. Here, there may be a difference in importance, cost, handling period between cases, and there may occur a problem not to decide the time point to complete all case exchange transaction between the two experts. However, such problems can be satisfactorily solved through a prior consultation between them.

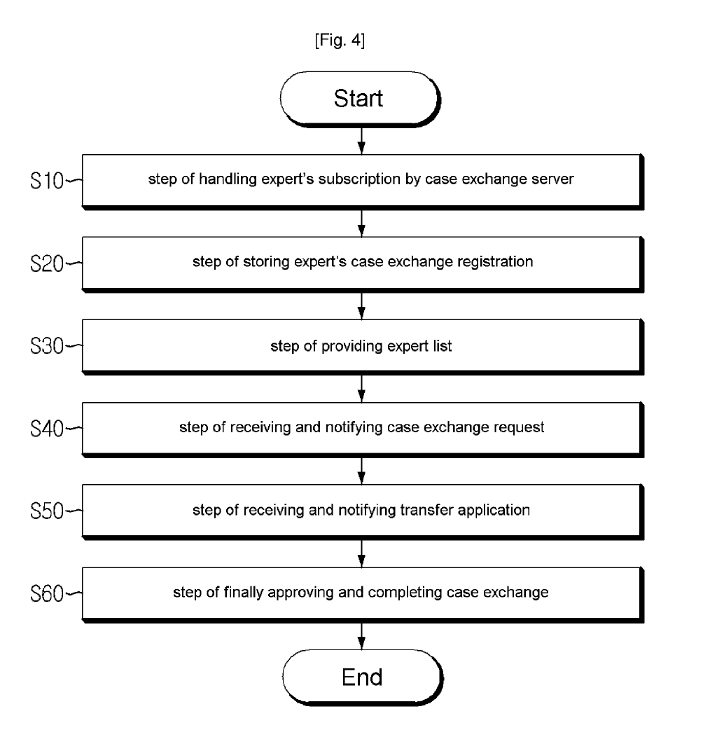

FIG. 4 shows a process for exchanging cases entrusted to the expert.

In a step for handling the expert's subscription (S10), the case exchanging server 2 receives a subscription from the expert terminal 3 through the wired or wireless network, and guides input of member information. When the member information transmitted by the expert is stored in the member information DB 211, the subscription process is completed. The member information includes the expert's personal information, specialized field, and career information of case handling related with the specialized field.

Here, the expert who joined as a member may request case exchange by directly selecting other expert engaged in the specialized field corresponding to the case registered by the expert (registrant), or inquire into other experts' registered cases and apply to transfer a case to him or her. A process that the expert positively requests case exchange to other expert will be described through steps (S20)˜(S60), and a process that the expert passively applies case transfer will be described through steps (S70)˜(S100).

After log-in to the case exchanging server 2, the expert transmits case exchange registration information including case information through the expert terminal 3, and the case exchanging server 2 stores it in the case exchange registration DB 221 (S20). The case exchange registration information includes information of the expert, who registered the case, (personal information+specialized field+career information of case handling), and case information consisting of case summary, case entrusting cost, case features, exchange conditions, and so on.

When the expert registered the case selects search of expert groups belonging to a category of the corresponding specialized field according to guide of the case exchanging server 2, the case exchanging server 2 inquires the member information DB 211 for members of the expert group belonging to the specialized field of the coincided category, creates the expert list, and then, transmits it to the expert terminal (S30).

When the expert selects at least one proper expert from the expert list and requests case exchange, the case exchanging server 2 receives case exchange request information, stores information of the selected expert in the case exchange request DB 241, and notifies the selected expert of request of case exchange using communication means registered as real time informing means by the selected expert. For example, the informing means may be E-mail or SMS (S40).

The selected expert reviews more detailed case exchange request information after receiving the notification of case exchange. If the selected expert has an intention to exchange the case and wants to apply case transfer, the selected expert requests a notification of transfer application information to the expert (registrant), who registered the case to the case exchanging server 2 (S50). In the same way, the expert (inquirer)'s transfer application is notified also to the expert (registrant) through the real time informing means.

The expert (registrant) inquires into the specialized fields and case handling careers of the candidate group who applied case transfer in connection with the expert (registrant)'s case, selects the final expert for case exchange, transmits it to the case exchanging server 2, and requests completion of case exchange. The case exchanging server 2 updates the case exchange request, which is now under way, into completion, so as to prevent other experts' transfer applications (S60).

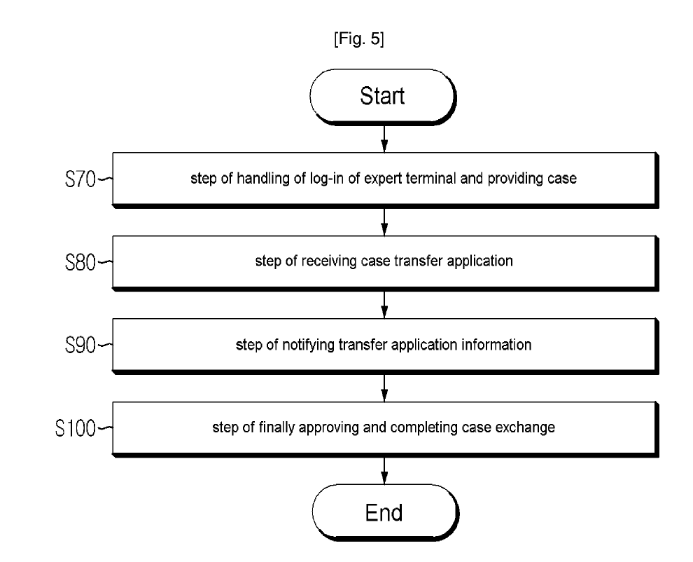

FIG. 5 shows a process for progressing a transfer application by other expert according to the present invention.

The process in FIG. 5 is a process that the expert (inquirer) inquires into other expert (registrant)'s registered case and request the expert to exchange the case with the expert (inquirer).

The expert logs in to the case exchanging server 2 through the wired or wireless network, and the case exchanging server 2 inquires the member information DB 211 in order to provide the initial screen on the expert terminal 3, searches a category registered as the expert (registrant)'s interested field, and then, searches cases corresponding to the category from the case exchange registration DB 221. The searched data is created as a case list, and provided to the expert terminal 3 (S70).

The expert selects an interested case from the case list, transmits a transfer application in order to request other expert of transfer of the case to the expert (registrant). After that, the case exchanging server 2 stores transfer application information in the transfer application DB 251.

The case exchanging server 2 notifies the registrant, who registered the case which is the object for the transfer application, of transfer application information in real time.

The expert (registrant) examines other experts' transfer applications, selects one expert for case exchange transaction, and transmits the final approval of the case exchange to the case exchanging server 2.

FIG. 6 shows a tree structure that cases and specialized fields are categorized.

FIG. 6 takes an instance of lawyers and patent attorneys. In case of the patent attorneys, categories defined as actual specialized fields in broad classification such as electronics, machinery and chemistry are exemplified. If the specialized category is subdivided into various cases and specialized fields such as semiconductor, communication engineering, circuit, or stationery, the object for exchange can be simply classified and easily searched, and the optimal expert can be selected in the corresponding category.

In case of the lawyers, all business bodies (private lawyers, joint law firms, judicial affairs associations, judicial affairs corporation, and so on) accept individual cases as individual business activities. In this instance, the present invention classifies cases entrusted to the lawyer group into criminal cases, civil cases, and other special cases, and enables a lawyer to exchange a wanted case with other lawyer engaged in each specialized field in a one-to-one manner in order to avoid ineffectiveness or hard fighting in a non-specialized field, which will be caused when the case is handled.

Assuming that a lawyer A is entrusted for a medical accident dispute case to tell whether or not a doctor made a mistake, and a lawyer B is entrusted for a dispute case of default and illegal act related with affiliation between companies, when the lawyer A judges that it is more effective to deal with the lawyer B's case and the lawyer B has expertise in handling the lawyer A's medical dispute case, the lawyers A and B register exchange request of their own cases and exchange their own cases with each other, whereby they can obtain an opportunity to provide clients with good legal services according to their expertise and know-how.

Moreover, in case of registered tax accountants, the present invention subdivides cases and specialized fields into lower specialized categories such as real estate sale tax category, additional tax category, and so on, thereby providing more improved expertise.

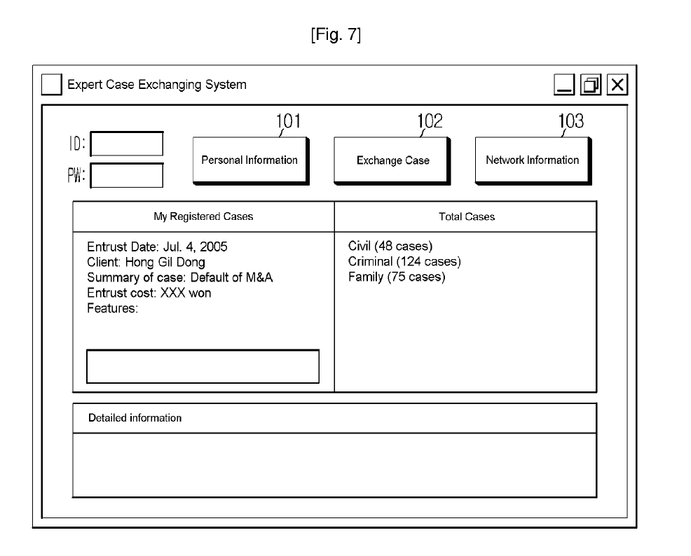

FIG. 7 shows an example of a screen configuration of the expert's case exchanging system according to the present invention.

In FIG. 7, a main screen includes a personal information button 101, an exchange case button 102, and a network information button 103.

The personal information button 101 converts the screen into a screen for inquiring, amending and deleting subscriber's member information, specialized field, and career information of case handling. Furthermore, the personal information button 101 provides a screen for inquiring the subscriber's entrusted cases, exchange cases, and cases which are now under way of the transfer application.

The exchange case button 102 converts the screen into a screen for enabling the subscriber to register an interested category and providing information of all cases registered in the corresponding category.

The network information button 103 converts the screen into a screen for publicly announcing experts' profiles, continuously accumulating quantitative analysis data in real time, and publicly announcing additional invitation for dealing with surplus cases, thereby aiding effective solidarity and consultation between expert groups and search of a proper expert occuring as a circulation result of the system for a long time.

Preferred embodiments of the system and method for exchanging cases entrusted to experts by clients are described above. While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### INDUSTRIAL APPLICABILITY

The system and method for exchanging cases entrusted to experts by clients according to the present invention provides an exchange service that an individual expert A in an expert group which has priority to expertise transfers a case entrusted by a client to other expert B who has better expertise and receives another case from the expert B in return for the case transfer, thereby enhancing expertise of the expert group and providing the client with more specialized service.

1. A system for exchanging cases entrusted to experts by clients in which experts in expert groups can exchange cases entrusted by clients with each other through a wired or wireless network, the system comprising:
an expert terminal for enabling an expert to register his or her specialized field and entrusted case information and request case exchange or to apply transfer of a case registered by other expert; and
a case exchanging server for mediating case exchange through the steps of receiving a subscription from the expert terminal, admitting experts' subscriptions in various fields, storing the expert's specialized field and career information of case handling received as member information in a member information DB, providing the information to other experts, receiving case exchange registration including case information, and providing the case exchange registration to other experts.

2. A system for exchanging cases entrusted to experts by clients according to claim 1, wherein the case exchanging server includes:
a member information for managing part receiving and admitting the expert's subscription and storing the expert's specialized field and career information of case handling as member information;
a case exchange registering part storing a case exchange registration including case information; a case public announcement part for publicly announcing the case registered for case exchange to other expert members;
a case exchange request managing part for receiving a case exchange request that the expert (registrant) selects at least one other expert and requests case exchange, and transmitting the case exchange request to the selected expert;
a transfer application managing part for receiving a transfer application that other expert (inquirer) who inquired the publicly announced case selects the expert (registrant) and applies transfer of the case, and transmitting it to the expert (registrant); and
an exchange approving part for transmitting exchange approval that the expert (registrant) finally approves case exchange to the at least one expert candidate who applied transfer of the case.

3. A system for exchanging cases entrusted to experts by clients according to claim 1, wherein the case or specialized field is classified into a predetermined category, and registered, inquired or amended in the case exchanging server or deleted from the case exchanging server.

4. A system for exchanging cases entrusted to experts by clients according to claim 1, wherein the experts may be connoisseurs, architects, patent attorneys, lawyers, licensed tax accountants, doctors, accountants, and so on.

5. A system for exchanging cases entrusted to experts by clients according to claim 1, wherein the case information includes summary, entrustment price, features, and exchange conditions of the case.

6. A system for exchanging cases entrusted to experts by clients according to claim 2, wherein the case exchanging server includes:
a member information DB for storing the expert's personal information, specialized field, and career information of case handling;
a case exchange registration DB for storing registration information of case exchange including information of the entrusted case;
a case exchange request DB for storing a case exchange request information that the expert (registrant) selects at least one other expert and requests case exchange; and
a transfer application DB for storing transfer application information that other expert (inquirer) who inquired into the publicly announced case selects the expert (registrant) and applies transfer of the case.

7. A method for exchanging cases entrusted to experts by clients in which a case exchanging server enables experts in expert groups to exchange cases entrusted by clients with each other through a wired or wireless network, the method comprising the steps of:
(1) receiving a subscription and member information from an expert terminal, storing them in a member information DB, and admitting the subscription by the case exchanging server;
(2) receiving case exchange registration information including case information from the expert terminal and storing it in a case exchange registration DB;
(3) inquiring and transmitting an expert list of a specialized field corresponding to the entrusted case to the expert terminal;
(4) when the expert terminal selects at least one other expert from the expert list and requests exchange of the case, notifying the selected expert of case exchange request information;
(5) when the selected expert reviews the case exchange request information and makes a transfer application, notifying the expert (registrant of the entrusted case) of transfer application information; and
(6) completing exchange of the entrusted case when the expert (registrant) receiving the notification of the transfer application information finally approves case transfer.

8. A method for exchanging cases entrusted to experts by clients according to claim 7, wherein the step (1) is a step of receiving the subscribed expert's personal information, specialized field, and career information of case handling in the specialized field from the expert and storing them in the member information DB.

9. A method for exchanging cases entrusted to experts by clients according to claim 7, wherein the step (2) is a step of receiving case exchange registration information including case information consisting of summary, entrustment price, features, and exchange conditions of the case and information of the expert who requests registration of the case, and storing it in the case exchange registration DB.

10. A method for exchanging cases entrusted to experts by clients according to claim 7, wherein the step (3) is a step of classifying the case or specialized field into a predetermined category, and registering, inquiring or amending them in the case exchanging server or deleted them from the case exchanging server.

11. A method for exchanging cases entrusted to experts by clients according to claim 7, wherein the step (4) or (5) is a step of transmitting the case exchange request information or the transfer application information through notifying means such as e-mail or SMS set up by the expert, and guiding usage of service on an initial screen when the expert logs in to the case exchanging server.

12. A method for exchanging cases entrusted to experts by clients according to claim 7, further comprising the steps of:
(7) providing a case list, that the case exchange is now under way, inquired from the case exchange registration DB after the case exchanging server deals with log-in of the expert terminal;
(8) receiving a transfer application of a specific case selected by the expert from the case list from the expert terminal;
(9) notifying the expert (registrant of the entrusted case) of transfer application information in real time by the case exchanging server; and
(10) completing exchange of the entrusted case when the expert (registrant) receives the notification of the transfer application information and finally approves case transfer.

13. A method for exchanging cases entrusted to experts by clients according to claim 12, wherein the step (7) is a step of searching cases corresponding to the previously registered field as the user's specialized field and interested field, creating the case list, and automatically providing the case list to the expert by the case exchanging server.

14. A system for exchanging cases entrusted to experts by clients according to claim 2, wherein the case or specialized field is classified into a predetermined category, and registered, inquired or amended in the case exchanging server or deleted from the case exchanging server.

15. A system for exchanging cases entrusted to experts by clients according to claim 2, wherein the experts may be connoisseurs, architects, patent attorneys, lawyers, licensed tax accountants, doctors, accountants, and so on.

16. A system for exchanging cases entrusted to experts by clients according to claim 2, wherein the case information includes summary, entrustment price, features, and exchange conditions of the case.
